(19) United States
(12) Patent Application Publication
(10) Pub. No.: US 2022/0138257 A1
(43) Pub. Date: May 5, 2022

(54) SYSTEM AND METHOD FOR JOURNEY RECORDING

(71) Applicant: GLASSBOX LTD., PETAH TIKVA (IL)

(72) Inventors: Yaron GUETA, Hod Hasharon (IL); Keren OREN, Ganey Tikva (IL)

(21) Appl. No.: 17/088,655

(22) Filed: Nov. 4, 2020

(51) Int. Cl. G06F 16/906

(52) U.S. Cl. CPC G06F 16/906

(57) ABSTRACT

A journey recording system, the journey recording system comprising a processing circuitry configured to: obtain (a) user journey information of a plurality of user journeys, each performed in a respective session within a website or a computerized application, each of the user journeys including information of a respective series of actions made by a corresponding user, within the website or the computerized application, in order to achieve a goal, (b) a user identifier associated with the corresponding user, and (c) one or more properties of the respective session; upon two or more of the sessions having (a) respective user identifiers that meet a first criterion, and (b) at least one respective property that meet a second criterion, determine that the two or more sessions are part of a multi-session journey; and associate the two or more journeys with a common multi-session identifier.

### TECHNICAL FIELD

The invention relates to a system and method for journey recording.

### BACKGROUND

A user digital journey is the flow of interactions a user has within a website or a computerized application. User digital journeys detail what are the different series of actions and phases or webpages users follow in order to achieve a specific goal within the website or computerized application. The user digital journey is performed by the user in a context of a session, an interactive information interchange between the user and the website or the computerized application from a first session interaction up to the user leaving the session. The user digital journey can be described as a funnel—the actions, phases and webpages the user goes through the website or the computerized application in order to navigate and complete the specific goal.

Current web session recording systems record and replay single-session user digital journeys, but they cannot track a multi-session user digital journey going through one funnel while utilizing multiple sessions on one or more user devices. For example, a user that starts a journey within a given funnel on his mobile device, stops the work in the midst of fulfilling the given funnel and later continues the given funnel from his desktop to accomplish the funnel's goal. Current systems will record these as two separate user journeys and will not identify the multi-session journey that actually occurred. There is thus a need in the art for a new method and system for journey recording.

References considered to be relevant as background to the presently disclosed subject matter are listed below. Acknowledgement of the references herein is not to be inferred as meaning that these are in any way relevant to the patentability of the presently disclosed subject matter.

U.S. Pat. No. 9,553,918 (Manion et al.) published on Jan. 24, 2017, discloses a stateful or stateless cookie operations server machine can provide real-time, actionable, user-specific tracking abilities in the collection of impressions and user interactions with a company's digital properties. The client-side code (e.g., in a web browser) may request an element configured with parameters and a hyperlink (e.g., URL) that causes parameters to be sent to a remote server. The remote server may process the parameters and perform various operations based on the parameters. Mathematical and/or other operations may be performed using the parameters. The remote server may retrieve a configuration corresponding to the request. The remote server may generate or transform content, based on the configuration. The remote server may transmit the transformed content.

US Patent Application No. 2013/0136253 (LIBERMAN BEN-AM et al.) published on May 30, 2013, discloses a device, system and method is provided for monitoring a user's interactions with Internet-based programs or documents. Content may be extracted from Internet server traffic according to predefined rules. Extracted content may be associated with a user's Internet interaction. The user's Internet interaction may be stored and indexed. The user's Internet interaction may be analyzed to generate a recommendation provided to a contact center agent while the contact center agent is communicating with said user for guiding the user's interaction, for example, in real-time. Traffic other than Internet server traffic may also be used.

US Patent Application No. 2019/0245974 (Dwyer et al.) published on Aug. 8, 2019, discloses a communication channel customer journey may involve receiving a first communication on a communication channel of a plurality of communication channels, wherein the first communication is associated with a contact, receiving at least one additional communication from the contact, wherein the at least one additional communication is on a same communication channel or is on a different communication channel of the plurality of communication channels, linking the first communication and the at least one additional communication by the contact, wherein linking involves storing information from at least one of a recording, a transcript, a copy of one or more of the first communication and the at least one additional communication, a language characteristic, an acoustic characteristic, a category, and a score, and enabling a user to navigate between all of the stored information for the first communication and the at least one additional communication.

US Patent Application No. 2009/0063968 (Wenig et al.) published on Mar. 5, 2009, discloses a user interface event monitor captures user interface events executed by a client during a network session. A network session monitor captures network data exchanged between the client and a web application during the network session. A replay device identifies control events in the network session that require execution before replaying associated user interface events. Replay of the user interface events are delayed by the replay device until the associated control events have been fully executed.

US Patent Application No. 2012/0303743 (Stonefield et al.) published on Nov. 29, 2012, discloses a user equipment (UE) participates in a coordinate-sharing communication session with at least one other UE that is arbitrated by a server (e.g., another UE participating in the session or an independent server). The UE displays a given visual representation of media content associated with the coordinate-sharing communication session. In an embodiment, the UE receives user input that indicates a selection of at least one coordinate of the given visual representation, and reports the coordinate selection(s) to the server via a coordinate packet. During the coordinate-sharing communication session, the server monitors for coordinate packets from the participating UEs and formats coordinate output frames indicative of selected coordinates at the respective UEs. In another embodiment, the UE receives a coordinate output frame indicative of coordinate selection(s) at the at least one other UE and selectively updates it's given visual representation accordingly.

U.S. Pat. No. 10,430,212 (Bekmambetov et al.) published on Oct. 1, 2019, discloses a method and system for recording, editing, and playback of user computer sessions, which captures a series of events during the session, including the initial state of desktop and all user interactions with the application(s). The events are recorded and stored on the server as a set of JSON objects, and the frames representing the session are editable, including insertion of different text, audio, video and images, into the recording. The recorder application comprises a core engine implemented in JavaScript and various server configurations available, either local or remote, for editing and playback.

### GENERAL DESCRIPTION

In accordance with a first aspect of the presently disclosed subject matter, there is provided a journey recording system, the journey recording system comprising a processing circuitry configured to: obtain (a) user journey information of a plurality of user journeys, each performed in a respective session within a website or a computerized application, each of the user journeys including information of a respective series of actions made by a corresponding user, within the website or the computerized application, in order to achieve a goal, (b) a user identifier associated with the corresponding user, and (c) one or more properties of the respective session; upon two or more of the sessions having (a) respective user identifiers that meet a first criterion, and (b) at least one respective property that meet a second criterion, determine that the two or more sessions are part of a multi-session journey; and associate the two or more journeys with a common multi-session identifier.

In some cases, upon the two or more journeys being associated with the common multi-session identifier, the processing circuitry configured to perform an action upon the two or more journeys.

In some cases, the action is one or more of: (a) visualizing the two or more journeys; (b) collecting data associated with the two or more journeys; (c) storing together the two or more journeys; (d) testing compliance of the two or more journeys; or (e) replaying the two or more sessions as one multi-session.

In some cases, upon the two or more journeys being associated with the common multi-session identifier, the processing circuitry configured to check if the respective series of actions made by the corresponding users of the two or more sessions achieve a multi-session goal.

In some cases, the user identifier is one or more of: user credentials associated with the corresponding user, an Internet Protocol (IP) address associated with the corresponding user, a customized user identifier associated with the corresponding website or the computerized application.

In some cases, the first criterion is identicality.

In some cases, each of the users is associated with a user group, and wherein the first criterion is that the users associated with the respective user identifiers are part of the same user group.

In some cases, the property is a timestamp of the respective session and wherein the second criteria is a time difference between the timestamp of a first session of the two or more sessions and the timestamp of other sessions of the two or more sessions is below a threshold.

In some cases, the property is a geo-location associated with the respective session and wherein the second criteria is a distance between the geo-location of a first session of the two or more sessions and the geo-location of other sessions of the two or more sessions is below a threshold.

In some cases, the computerized application is a mobile application.

In accordance with a second aspect of the presently disclosed subject matter, there is provided a journey recording method comprising: obtaining, by a processing circuitry, (a) user journey information of a plurality of user journeys, each performed in a respective session within a website or a computerized application, each of the user journeys including information of a respective series of actions made by a corresponding user, within the website or the computerized application, in order to achieve a goal, (b) a user identifier associated with the corresponding user, and (c) one or more properties of the respective session; upon two or more of the sessions having (a) respective user identifiers that meet a first criterion, and (b) at least one respective property that meet a second criterion, determining, by the processing circuitry, that the two or more sessions are part of a multi-session journey; and associating, by the processing circuitry, the two or more journeys with a common multi-session identifier.

In some cases, upon the two or more journeys being associated with the common multi-session identifier, the method further comprising performing, by the processing circuitry, an action upon the two or more journeys.

In some cases, the action is one or more of: (a) visualizing the two or more journeys; (b) collecting data associated with the two or more journeys; (c) storing together the two or more journeys; (d) testing compliance of the two or more journeys; or (e) replaying the two or more sessions as one multi-session.

In some cases, upon the two or more journeys being associated with the common multi-session identifier, the method further comprising checking, by the processing circuitry, if the respective series of actions made by the corresponding users of the two or more sessions achieve a multi-session goal.

In some cases, the user identifier is one or more of: user credentials associated with the corresponding user, an Internet Protocol (IP) address associated with the corresponding user, a customized user identifier associated with the corresponding website or the computerized application.

In some cases, the first criterion is identicality.

In some cases, each of the users is associated with a user group, and wherein the first criterion is that the users associated with the respective user identifiers are part of the same user group.

In some cases, the property is a timestamp of the respective session and wherein the second criteria is a time difference between the timestamp of a first session of the two or more sessions and the timestamp of other sessions of the two or more sessions is below a threshold.

In some cases, the property is a geo-location associated with the respective session and wherein the second criteria is a distance between the geo-location of a first session of the two or more sessions and the geo-location of other sessions of the two or more sessions is below a threshold.

In some cases, the computerized application is a mobile application.

In accordance with a third aspect of the presently disclosed subject matter, there is provided a non-transitory computer readable storage medium having computer readable program code embodied therewith, the computer readable program code, executable by at least one processor of a computer to perform a journey recording method comprising: obtaining, by a processing circuitry, (a) user journey information of a plurality of user journeys, each performed in a respective session within a website or a computerized application, each of the user journeys including information of a respective series of actions made by a corresponding user, within the website or the computerized application, in order to achieve a goal, (b) a user identifier associated with the corresponding user; and (c) one or more properties of the respective session; upon two or more of the sessions having (a) respective user identifiers that meet a first criterion, and (b) at least one respective property that meet a second criterion, determining, by the processing circuitry, that the two or more sessions are part of a multi-session journey; and associating, by the processing circuitry, the two or more journeys with a common multi-session identifier.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of example user journeys each performed in respective sessions, in accordance with the presently disclosed subject matter;

FIG. 2 is a block diagram schematically illustrating one example of a system for journey recording across sessions, in accordance with the presently disclosed subject matter; and

FIG. 3 is a flowchart illustrating one example of a sequence of operations carried out for journey recording across sessions, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “determining”, “replaying”, “checking” or the like, include action and/or processes of a computer that manipulate and/or transform data into other data, said data represented as physical quantities, e.g. such as electronic quantities, and/or said data representing the physical objects. The terms “computer”, “processor”, “processing resource”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

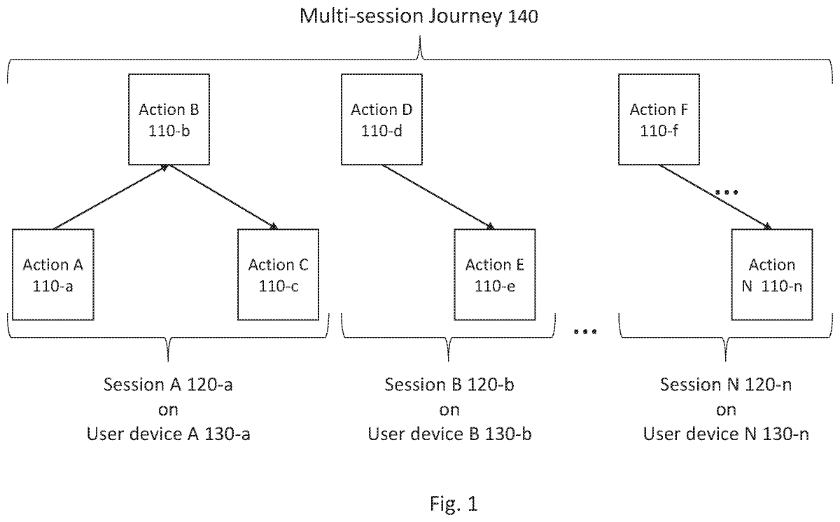

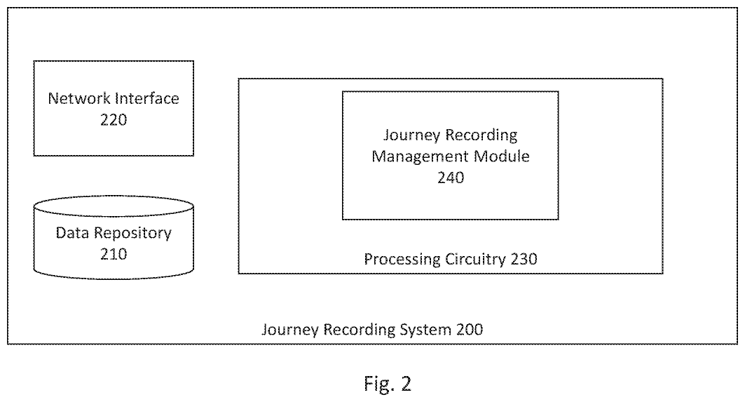

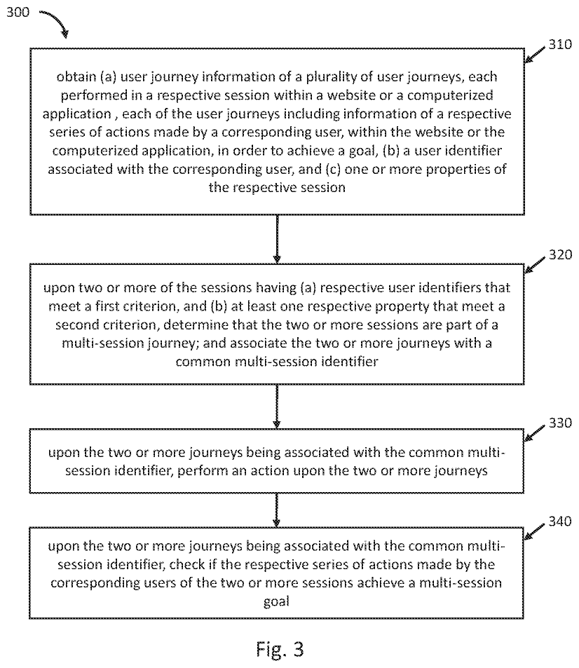

In embodiments of the presently disclosed subject matter, fewer, more and/or different stages than those shown in FIG. 3 may be executed. In embodiments of the presently disclosed subject matter one or more stages illustrated in FIG. 3 may be executed in a different order and/or one or more groups of stages may be executed simultaneously. FIGS. 1-2 illustrate a general schematic of the system architecture in accordance with an embodiment of the presently disclosed subject matter. Each module in FIGS. 1-2 can be made up of any combination of software, hardware and/or firmware that performs the functions as defined and explained herein. The modules in FIGS. 1-2 may be centralized in one location or dispersed over more than one location. In other embodiments of the presently disclosed subject matter, the system may comprise fewer, more, and/or different modules than those shown in FIGS. 1-2.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this in mind, attention is drawn to FIG. 1, a schematic illustration of example user journeys each performed in respective sessions, in accordance with the presently disclosed subject matter.

A user journey is the experiences a user has when interacting with software within a website or computerized application. The user journey is performed by the user in a context of a session (e.g. session A 120-a, session B 120-b, . . . , session N 120-n). A session is a temporary and interactive information interchange between the user and the website or the computerized application. An exemplary session is when the user is using a given web browser to interact with the website. When the user opens the website in a window of the given web browser the session starts. When the user closes that window the session ends, and when the user opens a different window of the given or another web browser to interact with the website a new session starts. It is to be noted that in some cases opening a new tab on the given web browser does not initiate a new session. Another example, for mobile applications, a new session is initiated when the mobile application is executed on a device of the user. The session ends for example, when the user closes the mobile application.

User journey information details what are the different series of actions (e.g. action A 110-a, action B 110-b, action C 110-c, action D 110-d, action E 110-e, action F 110-f, . . . , action N 110-n) users take in order to achieve a specific goal within the website or computerized application. The action can be any interaction between the user and the website or computerized application. For example: a user-interface action made by the user (such as: mouse clicks, choices made from a list, field completions, button presses), execution of a specific program, a passage of a given time period, etc. The user journey can be described as a funnel—the actions the user takes through the website or computerized application in order to navigate and complete the specific goal of the user journey.

The series of actions (e.g. action A 110-a, action B 110-b, action C 110-c, action D 110-d, action E 110-e, action F 110-f, . . . , action N 110-n) the user takes during the user journey are performed by the user utilizing a user device (e.g. user device A 130-a, user device B 130-b, . . . , user device N 130-n). The user device can be for example: a phone, a smart phone, a smart watch, a tablet, a desktop computer, a laptop, or any other computerized device used by the user to perform the actions.

A multi-session user journey 140 is a user journey that is associated with multiple sessions (e.g. session A 120-a, session B 120-b, . . . , session N 120-n) that run on one or more user devices (e.g. user device A 130-a, user device B 130-b, . . . , user device N 130-n). The multi-session user journey 140 can run through one funnel while utilizing multiple sessions on one or more user devices to achieve a goal. A non-limiting example is of a user that starts a multi-session user journey 140 on his mobile device, stops the work in the midst of performing the actions (not completing the series of actions) and later continues the series of actions from his desktop to accomplish the journey's goal.

A system can use one or more parameters of the sessions (e.g. session A 120-a, session B 120-b, . . . , session N 120-n)—like timestamp, user login, etc. to determine that a number of sessions are actually one session and record the multi-session user journey 140 through the funnel from one or more user devices (e.g. user device A 130-a, user device B 130-b, . . . , user device N 130-n) as one, as further detailed herein, inter alia with reference to FIG. 3.

In our non-limiting illustration, a first user journey is associated with session A 120-a that includes the following series of actions: action A 110-a, action B 110-b and action C 110-c performed by the user on user device A 130-a. A second user journey is associated with session B 120-b that includes the following series of action: action D 110-d and action E 110-e performed by the user on user device B 130-b. A third user journey is associated with session N 120-n that includes the following series of action: action F 110-f and action N 110-n performed by the user on user device C 130-c. Multi-session journey 140 is associated with the first, second and third user journeys, thus is associated with session A 120-a, session B 120-b and session N 120-n.

Having briefly described example user journeys each performed in respective sessions, attention is drawn to FIG. 2, a block diagram schematically illustrating one example of a system for journey recording across sessions, in accordance with the presently disclosed subject matter.

According to certain examples of the presently disclosed subject matter, journey recording system 200 can comprise a network interface 220 enabling connecting the system 200 to a network and enabling it to send and receive data sent thereto through the network, including in some cases receiving information such as: user journeys information and information about associated sessions (e.g. session A 120-a, session B 120-b, . . . , session N 120-n). In some cases, the network interface 220 can be connected to a Local Area Network (LAN), to a Wide Area Network (WAN), or to the Internet. In some cases, the network interface 220 can connect to a wireless network. It is to be noted that in some cases the received information, or part thereof, can be collected from one or more remote networks.

Journey recording system 200 can further comprise or be otherwise associated with a data repository 210 (e.g. a database, a storage system, a memory including Read Only Memory—ROM, Random Access Memory—RAM, or any other type of memory, etc.) configured to store data, including, inter alia, actions made by the user when interacting with the website or computerized application, user journeys information, information about sessions (e.g. session A 120-a, session B 120-b, . . . , session N 120-n) and their properties, information about user devices (e.g. user device A 130-a, user device B 130-b, . . . , user device N 130-n), information about one or more multi-session user journeys 140, etc.

In some cases, data repository 210 can be further configured to enable retrieval and/or update and/or deletion of the data stored thereon. It is to be noted that in some cases, data repository 210 can be distributed. It is to be noted that in some cases, data repository 210 can be stored in on cloud-based storage.

Journey recording system 200 further comprises processing circuitry 230. Processing circuitry 230 can be one or more processing circuitry units (e.g. central processing units), microprocessors, microcontrollers (e.g. microcontroller units (MCUs)) or any other computing devices or modules, including multiple and/or parallel and/or distributed processing circuitry units, which are adapted to independently or cooperatively process data for controlling relevant journey recording system 200 resources and for enabling operations related to journey recording system 200 resources.

The processing circuitry 230 comprises a journey recording management module 240, configured to perform a journey recording management process, as further detailed herein, inter alia with reference to FIG. 3.

Turning to FIG. 3, a flowchart illustrating one example of a sequence of operations carried out for journey recording across sessions, in accordance with the presently disclosed subject matter.

According to certain examples of the presently disclosed subject matter, journey recording system 200 can be configured to perform journey recording management process 300, e.g. utilizing the journey recording management module 240. The journey recording management process 300 will allow journey recording system 200 to associate multiple sessions (e.g. session A 120-a, session B 120-b, . . . , session N 120-n) to one multi-session user journey 140.

For this purpose, journey recording system 200 can be configured to obtain (a) user journey information of a plurality of user journeys, each performed in a respective session (e.g. session A 120-a, session B 120-b, . . . , session N 120-n) within a website or a computerized application, each of the user journeys including information of a respective series of actions (e.g. action A 110-a, action B 110-b, action C 110-c, action D 110-d, action E 110-e, action F 110-f, . . . , action N 110-n) made by a corresponding user, within the website or the computerized application, in order to achieve a goal, (b) a user identifier associated with the corresponding user, and (c) one or more properties of the respective session (e.g. session A 120-a, session B 120-b, . . . , session N 120-n) (block 310).

The one or more properties of the respective session (e.g. session A 120-a, session B 120-b, . . . , session N 120-n) can include: timestamp, start-time, end-time, geolocation of the user device (e.g. user device A 130-a, user device B 130-b, . . . , user device N 130-n) used to run the session, or any other property of the session.

In case the one or more properties of the respective session (e.g. session A 120-a, session B 120-b, . . . , session N 120-n) is a timestamp of the respective session, the second criteria can be a time difference between the tirnestamp of a first session of the two or more sessions and the timestamp of other sessions of the two or more sessions is below a threshold. For example, the time difference between the timestamps is below 5 minutes.

In case the one or more properties of the respective session (e.g. session A 120-a, session B 120-b, . . . , session N 120-n) is a geo-location associated with the respective session, the second criteria can be a distance between the geo-location of a first session of the two or more sessions and the geo-location of other sessions of the two or more sessions is below a threshold. For example, the distance between the geo-locations can be below 100 meters.

It is to be noted that in some cases the computerized application is a mobile application. The mobile application can be installed on a smart device of the user.

The user identifier is one or more of: user credentials associated with the corresponding user, an Internet Protocol (IP) address associated with the corresponding user, a customized user identifier associated with the corresponding website or the computerized application. Non-limiting examples of customized user identifiers are: a phone number, SSN, or any other customizable user identifier specific to the website or computerized application.

It is to be noted that switching between browsers used to browse the website can start a new session (e.g. session A 120-a, session B 120-b, . . . , session N 120-n).

A non-limiting example is obtaining information of a first user journey information of a plurality of actions (e.g. action A 110-a, action B 110-b, action C 110-c, action D 110-d, action E 110-e, action F 110-f, . . . , action N 110-n) made for searching for a certain hotel room and a second user journey information of a plurality of actions (e.g. action A 110-a, action B 110-b, action C 110-c, action D 110-d, action E 110-e, action F 110-f, . . . , action N 110-n) made for purchasing a night at that certain hotel room.

Upon two or more of the sessions having (a) respective user identifiers that meet a first criterion, and (b) at least one respective property that meet a second criterion, journey recording system 200 can be further configured to determine that the two or more sessions (e.g. session A 120-a, session B 120-b, . . . , session N 120-n) are part of a multi-session journey 140; and associate the two or more journeys with a common multi-session identifier (block 320).

Journey recording system 200 determines that the two or more sessions (e.g. session A 120-a, session B 120-b, . . . , session N 120-n) are part of a multi-session journey 140 by analyzing the user identifiers and the properties of the sessions (e.g. session A 120-a, session B 120-b, . . . , session N 120-n). The analysis of the user identifiers and the properties can be based on a criterion of identicality, similarity (for example: strings that are similar by more than a first threshold), association with a given group (for example: each of the users is associated with a user group, and the users associated with the respective user identifiers are part of the same user group). The analysis of the properties can be based for example on occurrence within a specific time window.

Continuing the non-limiting example above, the first session's end-time property and the second session's start-time property are within a specific time window. The user identifier associated with the first session and the user identifier associated with the second session are both associated with a given family group. Journey recording system 200 determines that both sessions are associated with one multi-session journey 140.

Upon the two or more journeys being associated with the common multi-session identifier, journey recording system 200 can be further configured to perform an action upon the two or more journeys (block 330).

The journey recording system 200 can use the common multi-session identifier of the multi-session user journey 140 to perform the following one or more actions: (a) visualize the journeys associated with the multi-session user journey 140, for example: by providing a user with one graphical representation of the journeys, (b) collect data associated with the journeys associated with the multi-session user journey 140, the collected data can be used for example for performing analytics, (c) store the journeys associated with the multi-session user journey 140 together, (d) test compliance of the journeys associated with the multi-session user journey 140 to one or more policies, rules or regulation, for example: use the journeys associated with the multi-session user journey 140 as evidence for compliance audits, (e) replay the journeys associated with the multi-session user journey 140, for example: one after the other, and (f) any other action upon the journeys associated with the multi-session user journey 140 that is available for a single journey. In our non-limiting example, journey recording system 200 can replay all the actions (e.g. action A 110-a, action B 110-b, action C 110-c, action D 110-d, action E 110-e, action F 110-f, . . . , action N 110-n) the user has taken, through the first session and the second session as part of one multi-session user journey 140. Upon the two or more journeys being associated with the common multi-session identifier, journey recording system 200 can be further configured to check if the respective series of actions made by the corresponding users of the two or more sessions achieve a multi-session goal (block 340).

It is to be noted that the multi-session goal can be a goal of one of the user journeys associated with the multi-session user journey 140 or a combination thereof.

Continuing our non-limiting example above, the multi-session goal is purchasing a night at a hotel. The actions (e.g. action A 110-a, action B 110-b, action C 110-c, action D 110-d, action E 110-e, action F 110-f, . . . , action N 110-n) associated with the first session (e.g. session A 120-a, session B 120-b, . . . , session N 120-n) followed by the action associated with the second session allowed the user to achieve the multi-session goal and to complete the purchase.

It is to be noted that, with reference to FIG. 3, some of the blocks can be integrated into a consolidated block or can be broken down to a few blocks and/or other blocks may be added. Furthermore, in some cases, the blocks can be performed in a different order than described herein (for example, block 340 can be performed before block 330, etc.). It is to be further noted that some of the blocks are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A journey recording system, the journey recording system comprising a processing circuitry configured to:
obtain (a) user journey information of a plurality of user journeys, each performed in a respective session within a website or a computerized application, each of the user journeys including information of a respective series of actions made by a corresponding user, within the website or the computerized application, in order to achieve a goal, (b) a user identifier associated with the corresponding user, and (c) one or more properties of the respective session;
upon two or more of the sessions having (a) respective user identifiers that meet a first criterion, and (b) at least one respective property that meet a second criterion, determine that the two or more sessions are part of a multi-session journey; and
associate the two or more journeys with a common multi-session identifier.

2. The journey recording system of claim 1, wherein upon the two or more journeys being associated with the common multi-session identifier, the processing circuitry configured to perform an action upon the two or more journeys.

3. The journey recording system of claim 2, wherein the action is one or more of:
(a) visualizing the two or more journeys;
(b) collecting data associated with the two or more journeys;
(c) storing together the two or more journeys;
(d) testing compliance of the two or more journeys; or
(e) replaying the two or more sessions as one multi-session.

4. The journey recording system of claim 1, wherein upon the two or more journeys being associated with the common multi-session identifier, the processing circuitry configured to check if the respective series of actions made by the corresponding users of the two or more sessions achieve a multi-session goal.

5. The journey recording system of claim 1, wherein the user identifier is one or more of: user credentials associated with the corresponding user, an Internet Protocol (IP) address associated with the corresponding user, a customized user identifier associated with the corresponding website or the computerized application.

6. The journey recording system of claim 1, wherein the first criterion is identicality.

7. The journey recording system of claim 1, wherein each of the users is associated with a user group, and wherein the first criterion is that the users associated with the respective user identifiers are part of the same user group.

8. The journey recording system of claim 1, wherein the property is a timestamp of the respective session and wherein the second criteria is a time difference between the timestamp of a first session of the two or more sessions and the timestamp of other sessions of the two or more sessions is below a threshold.

9. The journey recording system of claim 1, wherein the property is a geo-location associated with the respective session and wherein the second criteria is a distance between the geo-location of a first session of the two or more sessions and the geo-location of other sessions of the two or more sessions is below a threshold.

10. The journey recording system of claim 1, wherein the computerized application is a mobile application.

11. A journey recording method comprising:
obtaining, by a processing circuitry, (a) user journey information of a plurality of user journeys, each performed in a respective session within a website or a computerized application, each of the user journeys including information of a respective series of actions made by a corresponding user, within the website or the computerized application, in order to achieve a goal, (b) a user identifier associated with the corresponding user, and (c) one or more properties of the respective session;
upon two or more of the sessions having (a) respective user identifiers that meet a first criterion, and (b) at least one respective property that meet a second criterion, determining, by the processing circuitry, that the two or more sessions are part of a multi-session journey; and
associating, by the processing circuitry, the two or more journeys with a common multi-session identifier.

12. The journey recording method of claim 11, wherein upon the two or more journeys being associated with the common multi-session identifier, the method further comprising performing, by the processing circuitry, an action upon the two or more journeys.

13. The journey recording method of claim 12, wherein the action is one or more of:
(a) visualizing the two or more journeys;
(b) collecting data associated with the two or more journeys;
(c) storing together the two or more journeys;
(d) testing compliance of the two or more journeys; or
(e) replaying the two or more sessions as one multi-session.

14. The journey recording method of claim 11, wherein upon the two or more journeys being associated with the common multi-session identifier, the method further comprising checking, by the processing circuitry, if the respective series of actions made by the corresponding users of the two or more sessions achieve a multi-session goal.

15. The journey recording method of claim 11, wherein the user identifier is one or more of: user credentials associated with the corresponding user, an Internet Protocol (IP) address associated with the corresponding user, a customized user identifier associated with the corresponding website or the computerized application.

16. The journey recording method of claim 11, wherein the first criterion is identicality.

17. The journey recording method of claim 11, wherein each of the users is associated with a user group, and wherein the first criterion is that the users associated with the respective user identifiers are part of the same user group.

18. The journey recording method of claim 11, wherein the property is a timestamp of the respective session and wherein the second criteria is a time difference between the timestamp of a first session of the two or more sessions and the timestamp of other sessions of the two or more sessions is below a threshold.

19. The journey recording method of claim 11, wherein the property is a geo-location associated with the respective session and wherein the second criteria is a distance between the geo-location of a first session of the two or more sessions and the geo-location of other sessions of the two or more sessions is below a threshold.

20. A non-transitory computer readable storage medium having computer readable program code embodied therewith, the computer readable program code, executable by at least one processor of a computer to perform a journey recording method comprising:
obtaining, by a processing circuitry, (a) user journey information of a plurality of user journeys, each performed in a respective session within a website or a computerized application, each of the user journeys including information of a respective series of actions made by a corresponding user, within the website or the computerized application, in order to achieve a goal, (b) a user identifier associated with the corresponding user, and (c) one or more properties of the respective session;
upon two or more of the sessions having (a) respective user identifiers that meet a first criterion, and (b) at least one respective property that meet a second criterion, determining, by the processing circuitry, that the two or more sessions are part of a multi-session journey; and
associating, by the processing circuitry, the two or more journeys with a common multi-session identifier.
